(19) United States
(12) Patent Application Publication
(10) Pub. No.: US 2022/0290977 A1
(43) Pub. Date: Sep. 15, 2022

(54) THREE-DIMENSIONAL MEASUREMENT SYSTEM, METHOD, AND COMPUTER EQUIPMENT

(71) Applicant: ORBBEC INC., Shenzhen (CN)

(72) Inventors: Yuhua XU, SHENZHEN (CN); Bin XU, SHENZHEN (CN); Yushan YU, SHENZHEN (CN)

(21) Appl. No.: 17/828,923

(22) Filed: May 31, 2022

Related U.S. Application Data
(63) Continuation of application No. PCT/CN2020/141869, filed on Dec. 30, 2020.

(30) Foreign Application Priority Data
May 24, 2020 (CN) 202010445250.1

(51) Int. Cl. G01B 11/25

(52) U.S. Cl. CPC G01B 11/254

(57) ABSTRACT

A 3D measurement system includes: a projection module, configured to project an image to a target object, where the image includes at least three frames of phase shift fringe images and one frame of speckle image; an acquisition module, configured to acquire the phase shift fringe images and the speckle image; and a processor, configured to: calculate a relative phase of each pixel of the phase shift fringe images, match the speckle image with a pre-stored reference image, to obtain a first depth value of the pixel, perform phase unwrapping on the relative phase of the pixel according to the first depth value to determine an absolute phase of the pixel, and determine a second depth value of the pixel based on the absolute phase. An accurate depth value is calculated according to the absolute phase, thereby improving measurement accuracy.

### CROSS-REFERENCE TO RELATED APPLICATIONS

This application is a Continuation application of International Patent Application No. PCT/CN2020/141869, filed on Dec. 30, 2020, which is based on and claims priority to and benefits of Chinese Patent Application No. 202010445250.1, filed with the China National Intellectual Property Administration on May 24, 2020, and entitled “THREE-DIMENSIONAL MEASUREMENT SYSTEM AND METHOD, AND COMPUTER DEVICE.” The entire content of all of the above identified applications is incorporated herein by reference.

### TECHNICAL FIELD

This application relates to the field of three-dimensional (3D) measurement technologies, and in particular, to a 3D measurement system and method, and a computer device.

### BACKGROUND

3D reconstruction technologies are widely applied to fields such as 3D printing, machine vision, digital archaeology, and medical development. Currently popular methods include laser scanning, stereo vision, time of flight, and structured light.

In the structured light method based on speckle matching, a speckle image of a target scene is generally acquired and matched with a pre-stored reference image, to obtain a disparity map, and a depth structure or a 3D structure of the scene is calculated according to the disparity map and calibration parameters of a measurement system. The advantage of this method is that only a single frame of image is required to perform 3D measurement. However, the measurement accuracy is limited.

In existing 3D measurement methods, a phase shift method has advantages in measurement accuracy. A phase-shift-based system generally requires one projector and one or two cameras. In the phase shift method, more than three frames of phase shift fringe images generally need to be projected to a target scene. Because only a relative phase can be obtained merely with a single-frequency phase shift map, in order to obtain an absolute phase, a plurality of frames of phase shift maps with different frequencies further need to be projected, resulting in low measurement efficiency.

In a solution with a dual camera system, 3D measurement can be implemented by using only three types of patterns with embedded speckles. However, the system requires an additional camera, which increases hardware costs. In addition, the dual camera system further causes more shadow-related problems because a region can be measured only when the region is visible to all three devices.

In view of the foregoing problems in existing technologies, it is necessary to conduct development and research to provide a solution in which a compact 3D measurement system is used to perform 3D measurement on a target scene and rapid and accurate measurement can be implemented.

### SUMMARY

This application provides a 3D measurement system and method, and a computer device, to resolve at least one of the foregoing problems in BACKGROUND.

The embodiments of this application provide a 3D measurement system. The system includes: a projection module comprising a light emitting device and configured to project an image to a target object, where the image includes at least three frames of phase shift fringe images and one frame of speckle image; an acquisition module comprising a light sensor and configured to acquire the phase shift fringe images and the speckle image; and a processor, configured to: calculate a relative phase of each pixel according to the at least three frames of phase shift fringe images, match the speckle image with a pre-stored reference image to obtain a first depth value of the pixel, perform phase unwrapping on the relative phase of the pixel according to the first depth value to determine an absolute phase of the pixel, and calculate a second depth value of the pixel based on the absolute phase.

In some embodiments, the processor calculates projected image coordinates of the pixel according to the first depth value of the pixel, and calculates the absolute phase of the pixel according to the projected image coordinates by using a formula of:

$$φ = \frac{{X}_{p}}{W} 2 π N ,$$

where Xₚ is the projected image coordinates of the pixel, N is a quantity of fringes in the fringe images, w is a horizontal resolution of a projected image, and φ represents the absolute phase.

In some embodiments, the three frames of phase shift fringe images are represented as follows:

I₁(x,y)=I′(x,y)+I″(x,y)cos(φ(x,y)−2π/3)

I₂(x,y)=I′(x,y)+I″(x,y)cos(φ(x,y))

I₃(x,y)=I′(x,y)+I″(x,y)cos(φ(x,y)+2π/3),

where I′ represents an average brightness, I″ is an amplitude of a modulation signal, and φ represents the absolute phase.

In some embodiments, there is one projection module, and the projection module includes a projector that projects the at least three frames of phase shift fringe images and the one frame of speckle image to the target object.

In some embodiments, there are two projection modules configured to separately project patterns to the target object, one of the projection modules projects the speckle pattern, and the other projects the fringe pattern.

The embodiments of this application further provide a 3D measurement method. The method includes the following steps:

controlling a projection module to project an image to a target object, where the image includes at least three frames of phase shift fringe images and one frame of speckle image;

controlling an acquisition module to acquire the phase shift fringe images and the speckle image;

calculating a relative phase of each pixel of the at least three frames of phase shift fringe images, and matching the speckle image with a reference image, to obtain a first depth value of the pixel; and

performing phase unwrapping on the relative phase of the pixel according to the first depth value of the pixel to determine an absolute phase of the pixel, and calculating a second depth value of the pixel based on the absolute phase.

In some embodiments, the processor calculates projected image coordinates of the pixel according to the first depth value of the pixel, and calculates the absolute phase of the pixel according to the projected image coordinates by using a formula of:

$$φ = \frac{{X}_{p}}{W} 2 π N ,$$

where Xₚ is the projected image coordinates of the pixel, N is a quantity of fringes, w is a horizontal resolution of a projected image, and φ is the absolute phase.

In some embodiments, the three frames of phase shift fringe images are represented as follows:

I₁(x,y)=I′(x,y)+I″(x,y)cos(φ(x,y)−2π/3)

I₂(x,y)=I′(x,y)+I″(x,y)cos(φ(x,y))

I₃(x,y)=I′(x,y)+I″(x,y)cos(φ(x,y)+2π/3),

where I′ is an average brightness, I″ is an amplitude of a modulation signal, and φ is the absolute phase.

In some embodiments, the projection module includes a projector that projects the at least three frames of phase shift fringe images and the one frame of speckle image to the target object; or the projection module comprises a first project and a second projector, the first projector projects the one frame of speckle image, and the second projector projects the at least three frames of phase shift fringe images.

The embodiments of this application further provide a computer device. The computer device includes a memory, a processor, and a computer program that is stored in the memory and executable on the processor, where the processor, when executing the computer program, performs operations comprising: controlling a projection module to project an image to a target object, where the image includes at least three frames of phase shift fringe images and one frame of speckle image; controlling an acquisition module to acquire the phase shift fringe images and the speckle image; calculating a relative phase of each pixel of the at least three frames of phase shift fringe images, and matching the speckle image with a reference image, to obtain a first depth value of the pixel; and performing phase unwrapping on the relative phase of the pixel according to the first depth value to determine an absolute phase of the pixel, and calculating a second depth value of the pixel based on the absolute phase.

The embodiments of this application provide a 3D measurement system. The system includes: a projection module, configured to project an image to a target object, where the image includes at least three frames of phase shift fringe images and one frame of speckle image; an acquisition module, configured to acquire the phase shift fringe images and the speckle image; and a processor/a control and processing device, configured to: calculate a relative phase of each pixel of the at least three frames of phase shift fringe images, match the speckle image with a pre-stored reference image, to obtain a first depth value of the pixel, perform phase unwrapping on the relative phase of the pixel according to the first depth value to determine an absolute phase of the pixel, and calculate a second depth value of the pixel based on the absolute phase. In the embodiments of this application, at least three frames of phase shift fringe images and one frame of speckle image are projected. The speckle image is matched with a pre-stored reference image, to obtain a first depth value, and phase unwrapping is performed on relative phases in the three frames of phase shift fringe images according to the first depth value to obtain a more accurate absolute phase. An accurate depth value is calculated according to the absolute phase, thereby improving measurement accuracy.

### BRIEF DESCRIPTION OF THE DRAWINGS

To describe the technical solutions in the embodiments of this application or existing technologies more clearly, the following briefly describes the accompanying drawings required for describing the embodiments or the existing technologies. Apparently, the accompanying drawings in the following description show only some embodiments of this application, and a person of ordinary skill in the art may derive other drawings from the accompanying drawings without creative efforts.

FIG. 1 is a schematic diagram of a 3D measurement system, according to an embodiment of this application.

FIG. 2 is a diagram of the principle of calculating a depth value according to an absolute phase of a pixel in the 3D measurement system in the embodiment of FIG. 1.

FIG. 3 is a flowchart of a 3D measurement method, according to another embodiment of this application.

### DETAILED DESCRIPTION

To make the technical problems to be resolved by and the technical solutions and the advantageous effects of the embodiments of this application clearer and more comprehensible, the following further describes this application in detail with reference to the accompanying drawings and embodiments. It should be understood that the specific embodiments described herein are merely used to explain this application but are not intended to limit this application.

It should be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by the terms such as “length,” “width,” “above,” “below,” “front,” “back,” “left,” “right,” “vertical,” “horizontal,” “top,” “bottom,” “inside,” and “outside” are based on orientation or position relationships shown in the accompanying drawings, and are used only for ease and brevity of illustration and description of embodiments of this application, rather than indicating or implying that the mentioned apparatus or component needs to have a particular orientation or needs to be constructed and operated in a particular orientation. Therefore, such terms should not be construed as limiting this application.

In addition, terms “first” and “second” are used merely for the purpose of description, and shall not be construed as indicating or implying relative importance or implying a quantity of indicated technical features. Therefore, features defining “first” and “second” may explicitly or implicitly include one or more such features. In the description of the embodiments of this application, unless otherwise specifically limited, “a plurality of” means two or more than two.

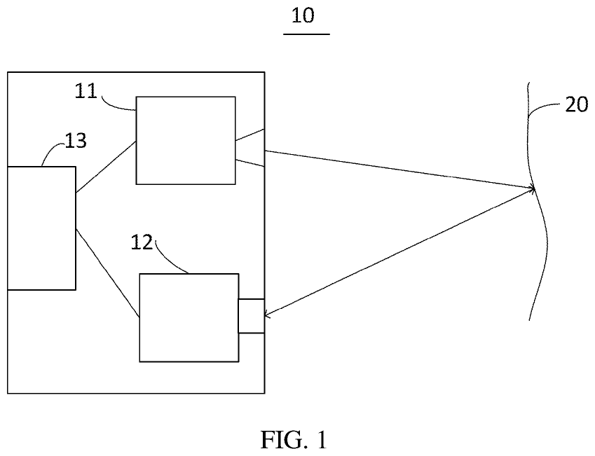

FIG. 1 is a schematic structural diagram of a 3D measurement system 10 according to an embodiment of this application. The 3D measurement system 10 includes a projection module 11, an acquisition module 12, and a control and processing device 13 separately connected to the projection module 11 and the acquisition module 12. The projection module 11 may comprise a light emitting device and is configured to project an image to a target object 20. The image includes at least three frames of phase shift fringe images and one frame of speckle image. The acquisition module 12 may comprise a light sensor and is configured to acquire the phase shift fringe images and the speckle image. The control and processing device, such as a processor, is configured to: calculate a relative phase of each pixel of the at least three frames of phase shift fringe images, match the acquired speckle image with a pre-stored reference image, to obtain a first depth value of the pixel, perform phase unwrapping on the relative phase of the pixel according to the first depth value to determine an absolute phase of the pixel, and calculate a second depth value of the pixel based on the absolute phase.

In some embodiments, the projection module 11 projects an image to the target object 20. The image includes three frames of fringe images and one frame of speckle image. In this embodiment of this application, the relative phase is obtained by using a phase shift method. A phase shift fringe pattern is projected onto a target surface, and a relative phase is calculated at each pixel of the phase shift fringe images. Descriptions are made by using a three-step phase-shift method as an example. A minimum quantity of phase shift fringe images in the three-step phase-shift method is three. Therefore, the image projected by the projection module includes at least three frames of fringe images (that is, three phase shift fringe images). It can be understood that using more phase shift fringe images can improve the accuracy of phase reconstruction.

The three frames of phase shift fringe images are used as an example. The three frames of phase shift fringe images may be represented by the following formula:

I₁(x,y)=I′(x,y)+I″(x,y)cos(φ(x,y)−2π/3)

I₂(x,y)=I′(x,y)+I″(x,y)cos(φ(x,y))

I₃(x,y)=I′(x,y)+I″(x,y)cos(φ(x,y)+2π/3), (1)

where I′ represents an average brightness, I″ is an amplitude of a modulation signal, and φ represents the absolute phase.

The control and processing device 13 calculates the relative phase of the pixel according to the foregoing formula, to obtain an expression of the absolute phase:

$${φ}^{′} ( x , y ) = arctan ( \frac{\sqrt{3} ( {I}_{1} - {I}_{3} )}{2 {I}_{2} - {I}_{1} - {I}_{3}} ) \qquad ( 2 )$$

$$φ ( x , y ) = {φ}^{′} ( x , y ) + 2 k π \qquad ( 3 )$$

where a value range of the relative phase is [−π, π], k represents a quantity of periods of fringes, φ′ represents the relative phase, and φ represents the absolute phase.

Assuming projected image coordinates of a pixel is Xp, an absolute phase of the pixel may be calculated according to the following formula:

$$φ = \frac{{X}_{p}}{W} 2 π N . \qquad ( 4 )$$

k in Formula (3) is the quantity of periods of fringes, and the quantity k of periods cannot be determined by using the three frames of fringe images. Therefore, to determine the absolute phase, a value of k needs to be determined. In this embodiment, a frame of speckle image is additionally projected and matched with the pre-stored reference image, to obtain a first depth value of the pixel. Phase unwrapping is performed on the relative phase according to the first depth value of the pixel to determine the value of k. First, the projected image coordinates Xp of the pixel are calculated according to the first depth value, and the absolute phase φ of the pixel is calculated according to Formula (4). The value of k can be determined according to Formula (3). Further, a more accurate second depth value Z2 of the pixel is calculated according to an absolute phase of a kth-level fringe.

In some embodiments, the control and processing device 13 matches the speckle image with the pre-stored reference image, and obtains, according to a disparity map of current view-angle images, a disparity value of a pixel (denoted as a point p) in the disparity map, so as to calculate a first depth value Z1 of the pixel. Projected image coordinates Xp of the pixel can be calculated according to the first depth value Z1, and an absolute phase of the pixel p then can be calculated according to Formula (4). Due to the limited matching accuracy of the speckle image, the first depth value Z1 is not accurate enough. Therefore, to obtain higher accuracy, phase unwrapping is performed on the relative phase φ′ by using the first depth value Z1 of the pixel p, to obtain a more accurate absolute phase. For example, the value of k can be obtained according to Formula (3), so that a more accurate second depth value Z2 of the pixel p can be calculated according to the absolute phase of the kth-level fringe.

Descriptions about performing phase unwrapping on the relative phase φ′ by using the first depth value Z1 of the point p, to obtain a more accurate absolute phase φ are made below in detail by using the pixel p as an example. In a case that parameters of the projection module 11 and the acquisition module 12 are known, the speckle image acquired by the acquisition module 12 is matched with the pre-stored reference image, to obtain 3D coordinates (X, Y, Z) of the point p. The 3D coordinates (X, Y, Z) of the point p are projected to an image plane. Coordinates of the projection to a camera image plane are recorded as x_{c}=(x_{c},y_{c})^{T}, and coordinates of the projection to a projected image are xₚ=(xₚ,yₚ)^{T}. Therefore, the following equation can be listed:

S_{C}X_{C}=K_{C}[R_{C}|T_{C}]X=P_{C}X

S_{P}X_{P}=K_{P}[R_{P}|T_{P}]X=P_{P}X, (5)

where X represents homogeneous coordinates of the 3D coordinates (X, Y, Z) of the point p, S_{C} and S_{P} represent scale factors, K_{C} and K_{P} represent internal parameter matrices, R_{P}|T_{P} and R_{C}|T_{C} represent external parameter matrices, and P_{C} and P_{P} respectively represent projection matrices of a camera and a projection, where

$${P}_{C} = ( \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34}\end{matrix} ) , \\ {P}_{P} = ( \begin{matrix}{p}_{11}^{′} & {p}_{12}^{′} & {p}_{13}^{′} & {p}_{14}^{′} \\ {p}_{21}^{′} & {p}_{22}^{′} & {p}_{23}^{′} & {p}_{24}^{′} \\ {p}_{31}^{′} & {p}_{32}^{′} & {p}_{33}^{′} & {p}_{34}^{′}\end{matrix} ) . \qquad ( 6 )$$

According to Formula (6), the 3D coordinates (X, Y, Z) of the point p may be represented by the following formula:

$$( \begin{matrix}X \\ Y \\ Z\end{matrix} ) = {( \begin{matrix}{p}_{11} - {p}_{31} {x}_{c} & {p}_{12} - {p}_{32} {x}_{c} & {p}_{13} - {p}_{33} {x}_{c} \\ {p}_{21} - {p}_{31} {y}_{c} & {p}_{22} - {p}_{32} {y}_{c} & {p}_{23} - {p}_{33} {y}_{c} \\ {p}_{11}^{′} - {p}_{31}^{′} {x}_{p} & {p}_{12}^{′} - {p}_{32}^{′} {x}_{p} & {p}_{13}^{′} - {p}_{33}^{′} {x}_{p}\end{matrix} )}^{- 1} ( \begin{matrix}{x}_{c} {p}_{34} - {p}_{14} \\ {y}_{c} {p}_{34} - {p}_{24} \\ {x}_{p} {p}_{34}^{′} - {p}_{14}^{′}\end{matrix} ) , \qquad ( 7 )$$

where x_{c} and y_{c} represent coordinates of the point p in the camera image, and xₚ and yₚ represent coordinates of the point p in the projected image.

Xp can be calculated according to Formula (7) by using the 3D coordinates (X, Y, Z) of the point p. The absolute phase φ of the point p can be calculated based on Xp by using Formula (4). The value of k can be calculated by using Formula (3). Because the calculation of the depth of the point p using fringes is based on an accurate phase value, and the phase shift method is more accurate than a block matching method, the accuracy of calculating a depth value of the point p by using fringe patterns is relatively high. Therefore, a more accurate second depth value Z2 of the point p can be calculated according to the absolute phase of the point p in the kth-level fringe.

In some embodiments, the control and processing device 13 calculates the projected image coordinates Xp of the pixel p according to the absolute phase of the point p in the kth-level fringe by using Formula (4), and then calculates the second depth value Z2 of the point p by using Formula (7).

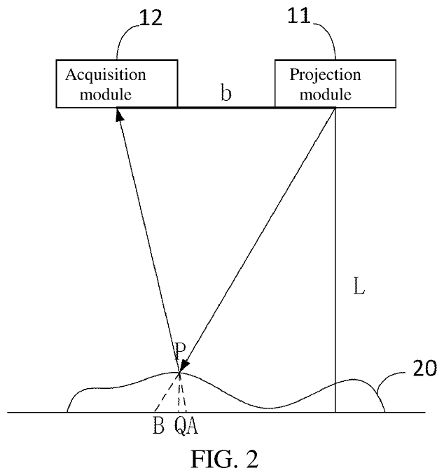

In some embodiments, the control and processing device 13 calculates the second depth value of the pixel p according to the absolute phase φ of the point p in the kth-level fringe by using a triangulation method. Referring to FIG. 2, the projection module 11 projects a fringe image to the target object 20. The acquisition module 12 acquires a fringe image reflected by the target object 20 and calculates the depth value of the point p by using a triangulation method.

$$\vert AB \vert = \frac{{φ}_{B} - {φ}_{B}}{2 π} λ \vert PQ \vert = \frac{\vert AB \vert * L}{b + \vert AB \vert} . \qquad ( 8 )$$

L is a distance from the projection module to a reference plane, b is a distance between the projection module and the acquisition module, φ_{B} represents an absolute phase of a point B, and φ_{A} represents an absolute phase of a point A.

The length of PQ can be obtained according to Formula (8), and the depth value of the point p can be obtained according to the following formula:

Z=L−PQ (9).

In some embodiments, there is one projection module 11, and the projection module 11 projects a speckle pattern and a fringe pattern to the target object, for example, by using a digital micromirror device (DMD). The DMD includes millions of micro mirror units that can be flipped. Each micro mirror unit of the DMD is a projection pixel, and each projection pixel is individually encoded. Therefore, any encoded pattern can be projected, including a speckle pattern and a fringe pattern. It can be understood that, alternatively, the speckle pattern and the fringe pattern may be projected to the target object by using one module formed by a combination of a vertical cavity surface emitting laser (VCSEL) and a lens and a micro-electro mechanical system (MEMS) or another combination.

In some embodiments, there are two projection modules 11 configured to separately project patterns to the target object, one of the projection modules 11 projects a speckle pattern, and the other projects a fringe pattern. For example, a combination of a VCSEL and a diffractive optical element (DOE) is used to project the speckle pattern to the target object, a combination of a VCSEL and a MEMS is used to project the fringe pattern to the target object, or a DMD is used to project the fringe pattern to the target object. It can be understood that there are many methods for projecting the speckle pattern and the fringe pattern, and a combination manner thereof is not limited in herein.

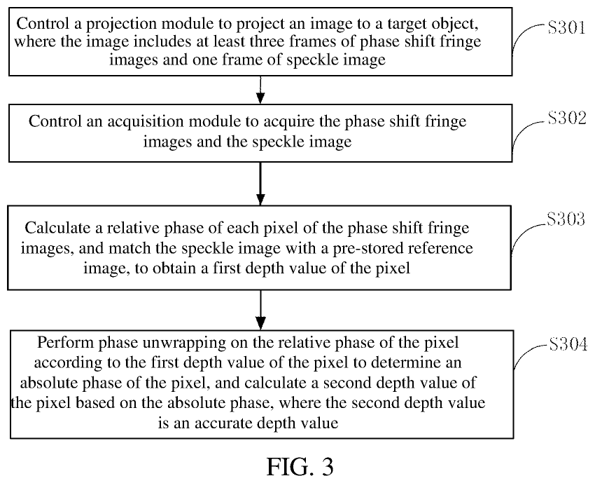

Referring to FIG. 3, another embodiment of this application further provides a 3D measurement method. The measurement method is implemented based on the 3D measurement system in the foregoing embodiments. FIG. 3 is a flowchart of a 3D measurement method according to an embodiment of this application. The measurement method includes the following steps.

S301: Controlling a projection module to project an image to a target object, where the projected image includes at least three frames of phase shift fringe images and one frame of speckle image.

In some embodiments, there is one single projection module, for example, a DMD. The projection module includes a plurality of micro mirror units. Each micro mirror unit is a projection pixel, and each projection pixel is individually encoded. Therefore, any encoded pattern can be projected, for example, a speckle pattern or a fringe pattern. Certainly, the single module may be alternatively a combination of a VCSEL, a lens, and a MEMS.

In some embodiments, the projection module are two modules. The two modules respectively project a fringe pattern and a speckle pattern to the target object. For example, a module combined by a light emitting device (e.g., VCSEL) and DOE projects the speckle pattern, and a DMD projects the fringe pattern.

S302: Controlling an acquisition module to acquire the phase shift fringe images and the speckle image.

Specifically, descriptions are made by using the three frames of phase shift fringe images as an example. The three frames of phase shift fringe images may be represented as:

I₁(x,y)=I′(x,y)+I″(x,y)cos(φ(x,y)−2π/3)

I₂(x,y)=I′(x,y)+I″(x,y)cos(φ(x,y))

I₃(x,y)=I′(x,y)+I″(x,y)cos(φ(x,y)+2π/3),

where I′ represents an average brightness, I″ is an amplitude of a modulation signal, and φ represents an absolute phase.

S303: Calculating a relative phase of each pixel of the phase shift fringe images, and match the speckle image with a pre-stored reference image, to obtain a first depth value of the pixel.

Specifically, according to the expression formulas of the phase shift fringe images in step S302, the relative phase may be represented as:

$${φ}^{′} ( x , y ) = arctan ( \frac{\sqrt{3} ( {I}_{1} - {I}_{3} )}{2 {I}_{2} - {I}_{1} - {I}_{3}} ) ,$$

where a value range of the relative phase is [−π, π].

It can be understood that, the matching the speckle image with a pre-stored reference image, to obtain a first depth value of the pixel may be implemented by using existing technologies. Details are not described herein again.

S304: Performing phase unwrapping on the relative phase of the pixel according to the first depth value of the pixel to determine an absolute phase of the pixel, and calculating a second depth value of the pixel based on the absolute phase, where the second depth value is an accurate depth value.

Specifically, phase unwrapping is performed according to the following formula to obtain projected image coordinates Xp of the pixel.

$$( \begin{matrix}X \\ Y \\ Z\end{matrix} ) = {( \begin{matrix}{p}_{11} - {p}_{31} {x}_{c} & {p}_{12} - {p}_{32} {x}_{c} & {p}_{13} - {p}_{33} {x}_{c} \\ {p}_{21} - {p}_{31} {y}_{c} & {p}_{22} - {p}_{32} {y}_{c} & {p}_{23} - {p}_{33} {y}_{c} \\ {p}_{11}^{′} - {p}_{31}^{′} {x}_{p} & {p}_{12}^{′} - {p}_{32}^{′} {x}_{p} & {p}_{13}^{′} - {p}_{33}^{′} {x}_{p}\end{matrix} )}^{- 1} ( \begin{matrix}{x}_{c} {p}_{34} - {p}_{14} \\ {y}_{c} {p}_{34} - {p}_{24} \\ {x}_{p} {p}_{34}^{′} - {p}_{14}^{′}\end{matrix} ) ,$$

where X, Y, and Z are 3D coordinates of a pixel p that are obtained by matching the speckle image with the pre-stored reference image, and x_{c} and y_{c} are pixel coordinates of the point p in a camera image.

The absolute phase of the pixel is calculated according to the projected image coordinates Xp by using the following formula:

$$φ = \frac{{X}_{p}}{W} 2 π N ,$$

where N is a quantity of fringes, w is a horizontal resolution of a projected image, and φ represents the absolute phase.

The second depth value of the point p is obtained according to the absolute phase φ of the point p by using a triangulation method. The second depth value is an accurate depth value.

The embodiments of this application further provide a storage medium configured to store a computer program. The computer program, when executed, performs at least the 3D measurement method described in the foregoing embodiment.

The storage medium may be implemented by using any type of volatile or non-volatile storage device or a combination thereof. The non-volatile memory may be a read-only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disc, or a compact disc read-only memory (CD-ROM), and the magnetic surface memory may be a magnetic disk memory or a magnetic tape memory. The volatile memory may be a random access memory (RAM), used as an external cache. Through exemplary but non-limitative descriptions, RAMs in lots of forms may be used, for example, a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a SyncLink dynamic random access memory (SLDRAM), and a direct Rambus random access memory (DRRAM). The storage medium described in this embodiment of this application aims to include but is not limited to these memories and any other suitable type of memory.

The embodiments of this application further provide a computer device. The computer device includes a memory, a processor, and a computer program that is stored in the memory and executable on the processor, where the processor, when executing the computer program, implements at least the 3D measurement method described in the foregoing embodiment.

A person skilled in the art may clearly understand that, for the purpose of convenient and brief description, only division of the foregoing function units and modules is used as an example for description. In the practical application, the functions may be allocated to and completed by different function units and modules according to requirements. That is, an internal structure of the apparatus is divided into different function units or modules, to complete all or some of the functions described above. Function units and modules in the embodiments may be integrated into one processing unit, or each of the units may exist alone physically, or two or more units are integrated into one unit. The integrated unit may be implemented in the form of hardware, or may be implemented in the form of a software function unit. In addition, the specific names of each functional unit and module are only for the purpose of distinguishing each other, and are not used to limit the protection scope of this application.

In the embodiments, descriptions of the embodiments have different emphases. As for parts that are not described in detail or recorded in one embodiment, reference can be made to the relevant descriptions of the other embodiments.

The foregoing embodiments are merely intended for describing the technical solutions of this application, but not for limiting this application. Although this application is described in detail with reference to the foregoing embodiments, it is to be understood by a person of ordinary skill in the art that they may still make modifications to the technical solutions described in the foregoing embodiments or make equivalent replacements to some technical features thereof, without departing from the spirit and scope of the technical solutions of the embodiments of this application, which being included in the protection scope of this application.

What is claimed is:

1. A three-dimensional (3D) measurement system, comprising:
a projection module comprising a light emitting device and configured to project an image to a target object, wherein the image comprises at least three frames of phase shift fringe images and one frame of speckle image;
an acquisition module comprising a light sensor and configured to acquire the phase shift fringe images and the speckle image; and
a processor configured to: calculate a relative phase of each pixel of the at least three frames of phase shift fringe images, match the speckle image with a pre-stored reference image to obtain a first depth value of the pixel, perform phase unwrapping on the relative phase of the pixel according to the first depth value to determine an absolute phase of the pixel, and calculate a second depth value of the pixel based on the absolute phase.

2. The system according to claim 1, wherein the processor calculates projected image coordinates of the pixel according to the first depth value of the pixel, and calculates the absolute phase of the pixel according to the projected image coordinates by using a formula of
$$φ = \frac{{X}_{p}}{W} 2 π N ,$$
wherein Xₚ is the projected image coordinates of the pixel, N is a quantity of fringes in the fringe images, w is a horizontal resolution of the projected image, and φ is the absolute phase.

3. The system according to claim 1, wherein the three frames of phase shift fringe images are represented as follows:
I₁(x,y)=I′(x,y)+I″(x,y)cos(φ(x,y)−2π/3)
I₂(x,y)=I′(x,y)+I″(x,y)cos(φ(x,y))
I₃(x,y)=I′(x,y)+I″(x,y)cos(φ(x,y)+2π/3),
wherein I′ is an average brightness, I″ is an amplitude of a modulation signal, and φ is the absolute phase.

4. The system according to claim 1, wherein the projection module includes a projector that projects the at least three frames of phase shift fringe images and the one frame of speckle image to the target object.

5. The system according to claim 1, wherein the projection module comprises a first project and a second projector, the first projector projects the one frame of speckle image, and the second projector projects the at least three frames of phase shift fringe images.

6. A three-dimensional (3D) measurement method, comprising:
controlling a projection module comprising a light emitting device to project an image to a target object, wherein the image comprises at least three frames of phase shift fringe images and one frame of speckle image;
controlling an acquisition module comprising a light sensor to acquire the phase shift fringe images and the speckle image;
calculating a relative phase of each pixel of the at least three frames of phase shift fringe images, and matching the speckle image with a pre-stored reference image to obtain a first depth value of the pixel; and
performing phase unwrapping on the relative phase of the pixel according to the first depth value to determine an absolute phase of the pixel, and calculating a second depth value of the pixel based on the absolute phase.

7. The method according to claim 6, further comprising calculating projected image coordinates of the pixel according to the first depth value of the pixel, and calculating the absolute phase of the pixel according to the projected image coordinates by using a formula of
$$φ = \frac{{X}_{p}}{W} 2 π N ,$$
wherein Xₚ is the projected image coordinates of the pixel, N is a quantity of fringes, w is a horizontal resolution of the projected image, and φ is the absolute phase.

8. The method according to claim 6, wherein the three frames of phase shift fringe images are represented as follows:
I₁(x,y)=I′(x,y)+I″(x,y)cos(φ(x,y)−2π/3)
I₂(x,y)=I′(x,y)+I″(x,y)cos(φ(x,y))
I₃(x,y)=I′(x,y)+I″(x,y)cos(φ(x,y)+2π/3),
wherein I′ is an average brightness, I″ is an amplitude of a modulation signal, and φ is the absolute phase.

9. The method according to claim 6, wherein the projection module includes a projector that projects the at least three frames of phase shift fringe images and the one frame of speckle image to the target object.

10. The method according to claim 6, wherein the projection module comprises a first project and a second projector, the first projector projects the one frame of speckle image, and the second projector projects the at least three frames of phase shift fringe images.

11. A computer device, comprising a memory, a processor, and a computer program that is stored in the memory and executable on the processor, wherein the processor, when executing the computer program, performs operations comprising:
controlling a projection module comprising a light emitting device to project an image to a target object, wherein the image comprises at least three frames of phase shift fringe images and one frame of speckle image;
controlling an acquisition module comprising a light sensor to acquire the phase shift fringe images and the speckle image;
calculating a relative phase of each pixel of the at least three frames of phase shift fringe images, and matching the speckle image with a pre-stored reference image, to obtain a first depth value of the pixel; and
performing phase unwrapping on the relative phase of the pixel according to the first depth value to determine an absolute phase of the pixel, and calculating a second depth value of the pixel based on the absolute phase.

12. The computer device of claim 11, wherein the operations further comprise calculating projected image coordinates of the pixel according to the first depth value of the pixel, and calculating the absolute phase of the pixel according to the projected image coordinates by using a formula of
$$φ = \frac{{X}_{p}}{W} 2 π N ,$$
wherein Xₚ is the projected image coordinates of the pixel, N is a quantity of fringes, w is a horizontal resolution of the projected image, and φ is the absolute phase.

13. The computer device of claim 11, wherein the three frames of phase shift fringe images are represented as follows:
I₁(x,y)=I′(x,y)+I″(x,y)cos(φ(x,y)−2π/3)
I₂(x,y)=I′(x,y)+I″(x,y)cos(φ(x,y))
I₃(x,y)=I′(x,y)+I″(x,y)cos(φ(x,y)+2π/3),
wherein I′ is an average brightness, I″ is an amplitude of a modulation signal, and φ is the absolute phase.

14. The computer device of claim 11, wherein the projection module includes a projector that projects at least three frames of phase shift fringe images and the one frame of speckle image to the target object.

15. The computer device of claim 11, wherein the projection module comprises a first project and a second projector, the first projector projects the one frame of speckle image, and the second projector projects the at least three frames of phase shift fringe images.
